(19) United States
(12) Patent Application Publication
(10) Pub. No.: US 2016/0380950 A1
(43) Pub. Date: Dec. 29, 2016

(54) SYSTEM AND METHOD FOR DETECTING EXPERTISE VIA MEETING PARTICIPATION

(71) Applicant: International Business Machines Corporation, Armonk, NY (US)

(72) Inventors: STEPHEN J. FOLEY, Quincy, MA (US); Amy D. Travis, Arlington, MA (US)

(21) Appl. No.: 14/751,291

(22) Filed: Jun. 26, 2015

(51) Int. Cl. H04L 12/58; H04L 12/26

(52) U.S. Cl. CPC H04L 51/32; H04L 51/12; H04L 43/16

(57) ABSTRACT

A method, computer program product, and computer system for determining, by a computing device, a topic of a meeting. Participation of a meeting attendant during the meeting may be tracked. Content of the participation from the meeting attendant may be analyzed. It may be determined that the meeting attendant is an expert on the topic of the meeting based upon, at least in part, the content of the participation. It may be shared, via a social network, that the meeting attendant is the expert on the topic of the meeting.

### BACKGROUND

Someone's behavior, e.g., in meetings, may help discern whether that person may be an expert on a particular topic. However, those who were not attending the meeting may not see that behavior to discern whether that person may be an expert on a particular topic. While the attendees of the meeting may be aware of who the experts are, unless those attendees explicitly share that information with others (e.g., by tagging the profile of the experts), the dissemination of that information about the expertise of the attendees is limited.

### BRIEF SUMMARY OF DISCLOSURE

In one example implementation, a method, performed by one or more computing devices, may include but is not limited to determining, by a computing device, a topic of a meeting. Participation of a meeting attendant during the meeting may be tracked. Content of the participation from the meeting attendant may be analyzed. It may be determined that the meeting attendant is an expert on the topic of the meeting based upon, at least in part, the content of the participation. It may be shared, via a social network, that the meeting attendant is the expert on the topic of the meeting.

One or more of the following example features may be included. Determining that the meeting attendant is the expert on the topic of the meeting may include counting how often the meeting attendant participates in the meeting. Determining that the meeting attendant is the expert on the topic of the meeting may include determining that the content of the participation involves the topic of the meeting. Determining that the content of the participation involves the topic of the meeting may include determining that the content of the participation occurs while displaying a slide incorporating the topic of the meeting. Analyzing content of the participation from the meeting attendant may include analyzing audio of the participation from the meeting attendant. Analyzing content of the participation from the meeting attendant may include analyzing text of the participation from the meeting attendant. Determining that the meeting attendant is the expert on the topic of the meeting may include scoring the content of the participation based upon, at least in part, whether the content is one of an answer and a question.

In another example implementation, a computing system includes a processor and a memory configured to perform operations that may include but are not limited to determining a topic of a meeting. Participation of a meeting attendant during the meeting may be tracked. Content of the participation from the meeting attendant may be analyzed. It may be determined that the meeting attendant is an expert on the topic of the meeting based upon, at least in part, the content of the participation. It may be shared, via a social network, that the meeting attendant is the expert on the topic of the meeting.

One or more of the following example features may be included. Determining that the meeting attendant is the expert on the topic of the meeting may include counting how often the meeting attendant participates in the meeting. Determining that the meeting attendant is the expert on the topic of the meeting may include determining that the content of the participation involves the topic of the meeting. Determining that the content of the participation involves the topic of the meeting may include determining that the content of the participation occurs while displaying a slide incorporating the topic of the meeting. Analyzing content of the participation from the meeting attendant may include analyzing audio of the participation from the meeting attendant. Analyzing content of the participation from the meeting attendant may include analyzing text of the participation from the meeting attendant. Determining that the meeting attendant is the expert on the topic of the meeting may include scoring the content of the participation based upon, at least in part, whether the content is one of an answer and a question.

In another example implementation, a computer program product resides on a computer readable storage medium that has a plurality of instructions stored on it. When executed by a processor, the instructions cause the processor to perform operations that may include but are not limited to determining a topic of a meeting. Participation of a meeting attendant during the meeting may be tracked. Content of the participation from the meeting attendant may be analyzed. It may be determined that the meeting attendant is an expert on the topic of the meeting based upon, at least in part, the content of the participation. It may be shared, via a social network, that the meeting attendant is the expert on the topic of the meeting.

One or more of the following example features may be included. Determining that the meeting attendant is the expert on the topic of the meeting may include counting how often the meeting attendant participates in the meeting. Determining that the meeting attendant is the expert on the topic of the meeting may include determining that the content of the participation involves the topic of the meeting. Determining that the content of the participation involves the topic of the meeting may include determining that the content of the participation occurs while displaying a slide incorporating the topic of the meeting. Analyzing content of the participation from the meeting attendant may include analyzing audio of the participation from the meeting attendant. Analyzing content of the participation from the meeting attendant may include analyzing text of the participation from the meeting attendant. Determining that the meeting attendant is the expert on the topic of the meeting may include scoring the content of the participation based upon, at least in part, whether the content is one of an answer and a question.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of an expert detection process coupled to a distributed computing network according to one or more example implementations of the disclosure;

FIG. 2 is an example diagrammatic view of a client electronic device of FIG. 1 according to one or more example implementations of the disclosure;

FIG. 3 is an example flowchart of the expert detection process of FIG. 1 according to one or more example implementations of the disclosure;

FIG. 4 is an example diagrammatic view of a screen image displayed by the expert detection process of FIG. 1 according to one or more example implementations of the disclosure;

FIG. 5 is an example diagrammatic view of a screen image displayed by the expert detection process of FIG. 1 according to one or more example implementations of the disclosure;

FIG. 6 is an example diagrammatic view of a screen image displayed by the expert detection process of FIG. 1 according to one or more example implementations of the disclosure; and

FIG. 7 is an example diagrammatic view of a screen image displayed by the expert detection process of FIG. 1 according to one or more example implementations of the disclosure.

Like reference symbols in the various drawings indicate like elements.

### DETAILED DESCRIPTION

### System Overview:

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

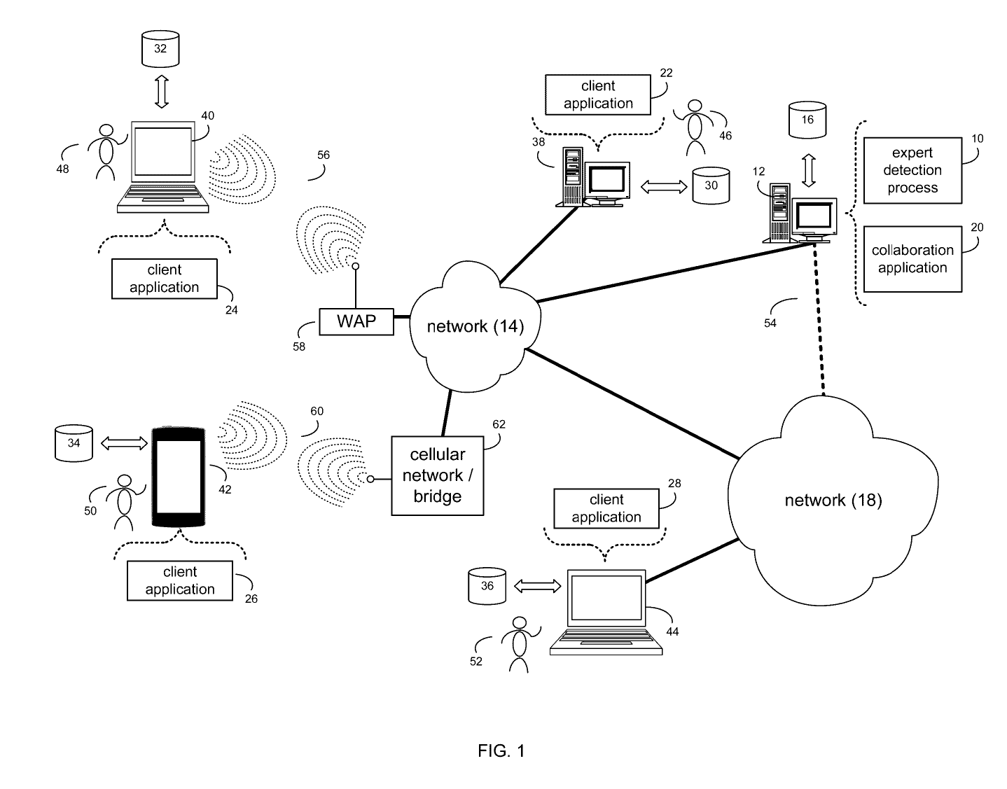

Referring now to FIG. 1, there is shown expert detection process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, expert detection process 10 may determine a topic of a meeting. Participation of a meeting attendant during the meeting may be tracked. Content of the participation from the meeting attendant may be analyzed. It may be determined that the meeting attendant is an expert on the topic of the meeting based upon, at least in part, the content of the participation. It may be shared, via a social network, that the meeting attendant is the expert on the topic of the meeting.

The instruction sets and subroutines of expert detection process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, triplestore database, etc.) and may be located within any suitable memory location, such as storage device 16 coupled to computer 12. Any data described throughout the present disclosure may be stored in the data store. In some implementations, computer 12 may utilize a database management system such as, but not limited to, “My Structured Query Language” (MySQL®) in order to provide multi-user access to one or more databases, such as the above noted relational database. The data store may also be a custom database, such as, for example, a flat file database or an XML database. Any other form(s) of a data storage structure and/or organization may also be used. Expert detection process 10 may be a component of the data store, a stand alone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute a collaboration application (e.g., collaboration application 20), examples of which may include, but are not limited to, e.g., a web conferencing application, a video conferencing application, a voice-over-IP application, a video-over-IP application, an Instant Messaging (IM)/“chat” application, short messaging service (SMS)/multimedia messaging service (MMS) application, social network/social media application, or other application that allows for virtual meeting and/or remote collaboration, and/or social network activities (e.g., posting, profile searching/viewing, messaging, etc.). Expert detection process 10 and/or collaboration application 20 may be accessed via client applications 22, 24, 26, 28. Expert detection process 10 may be a stand alone application, or may be an applet/application/script/extension that may interact with and/or be executed within collaboration application 20, a component of collaboration application 20, and/or one or more of client applications 22, 24, 26, 28. Collaboration application 20 may be a stand alone application, or may be an applet/application/script/extension that may interact with and/or be executed within expert detection process 10, a component of expert detection process 10, and/or one or more of client applications 22, 24, 26, 28. One or more of client applications 22, 24, 26, 28 may be a stand alone application, or may be an applet/application/script/extension that may interact with and/or be executed within and/or be a component of expert detection process 10 and/or collaboration application 20. Examples of client applications 22, 24, 26, 28 may include, but are not limited to, e.g., a web conferencing application, a video conferencing application, a voice-over-IP application, a video-over-IP application, an Instant Messaging (IM)/“chat” application, short messaging service (SMS)/multimedia messaging service (MMS) application, social network/social media application, or other application that allows for virtual meeting and/or remote collaboration, and/or social network activities (e.g., posting, profile searching/viewing, messaging, etc.), a standard and/or mobile web browser, an email client application, a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android™, Apple® iOS®, Mac® OS X®; Red Hat® Linux®, or a custom operating system.

One or more of client applications 22, 24, 26, 28 may be configured to effectuate some or all of the functionality of expert detection process 10 (and vice versa). Accordingly, expert detection process 10 may be a purely server-side application, a purely client-side application, or a hybrid server-side/client-side application that is cooperatively executed by one or more of client applications 22, 24, 26, 28 and/or expert detection process 10.

One or more of client applications 22, 24, 26, 28 may be configured to effectuate some or all of the functionality of collaboration application 20 (and vice versa). Accordingly, collaboration application 20 may be a purely server-side application, a purely client-side application, or a hybrid server-side/client-side application that is cooperatively executed by one or more of client applications 22, 24, 26, 28 and/or collaboration application 20. As one or more of client applications 22, 24, 26, 28, expert detection process 10, and collaboration application 20, taken singly or in any combination, may effectuate some or all of the same functionality, any description of effectuating such functionality via one or more of client applications 22, 24, 26, 28, expert detection process 10, collaboration application 20, or combination thereof, and any described interaction(s) between one or more of client applications 22, 24, 26, 28, expert detection process 10, collaboration application 20, or combination thereof to effectuate such functionality, should be taken as an example only and not to limit the scope of the disclosure.

Users 46, 48, 50, 52 may access computer 12 and expert detection process 10 (e.g., using one or more of client electronic devices 38, 40, 42, 44) directly through network 14 or through secondary network 18. Further, computer 12 may be connected to network 14 through secondary network 18, as illustrated with phantom link line 54. Expert detection process 10 may include one or more user interfaces, such as browsers and textual or graphical user interfaces, through which users 46, 48, 50, 52 may access expert detection process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, and/or Bluetooth™ (including Bluetooth Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

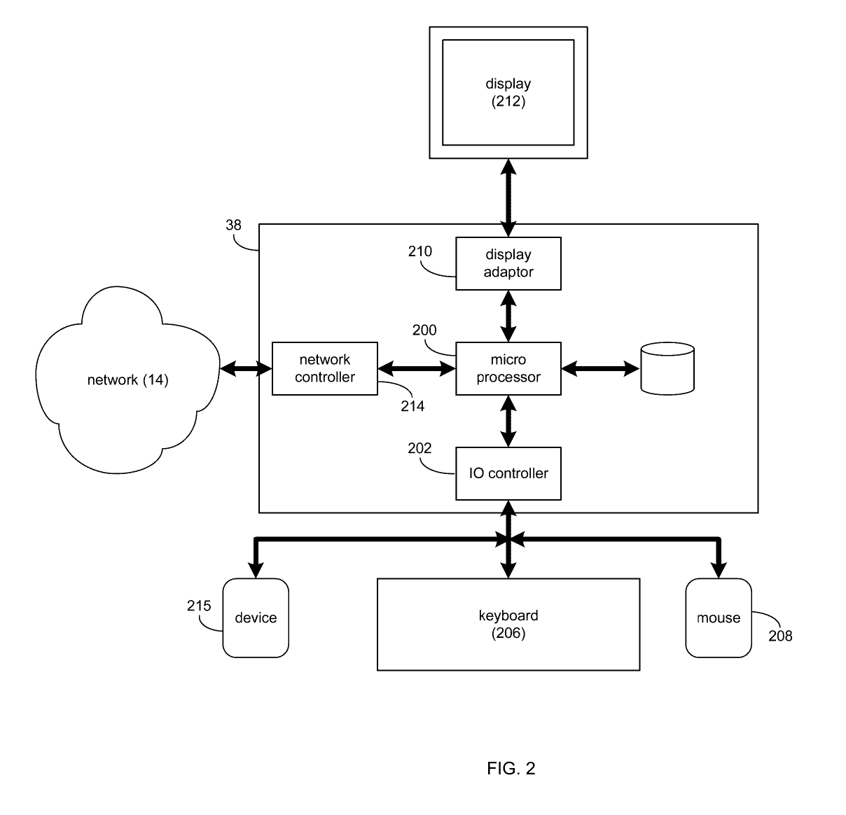

Referring also to FIG. 2, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, expert detection process 10 may be substituted for client electronic device 38 within FIG. 2, examples of which may include but are not limited to computer 12 and/or client electronic devices 40, 42, 44.

Client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device(s) (e.g., storage device 30). An I/O controller (e.g., I/O controller 202) may be configured to couple microprocessor 200 with various devices, such as keyboard 206, pointing/selecting device (e.g., mouse 208), custom device (e.g., device 215), USB ports (not shown), and printer ports (not shown). A display adaptor (e.g., display adaptor 210) may be configured to couple display 212 (e.g., CRT or LCD monitor(s)) with microprocessor 200, while network controller/adaptor 214 (e.g., an Ethernet adaptor) may be configured to couple microprocessor 200 to the above-noted network 14 (e.g., the Internet or a local area network).

The Expert Detection Process:

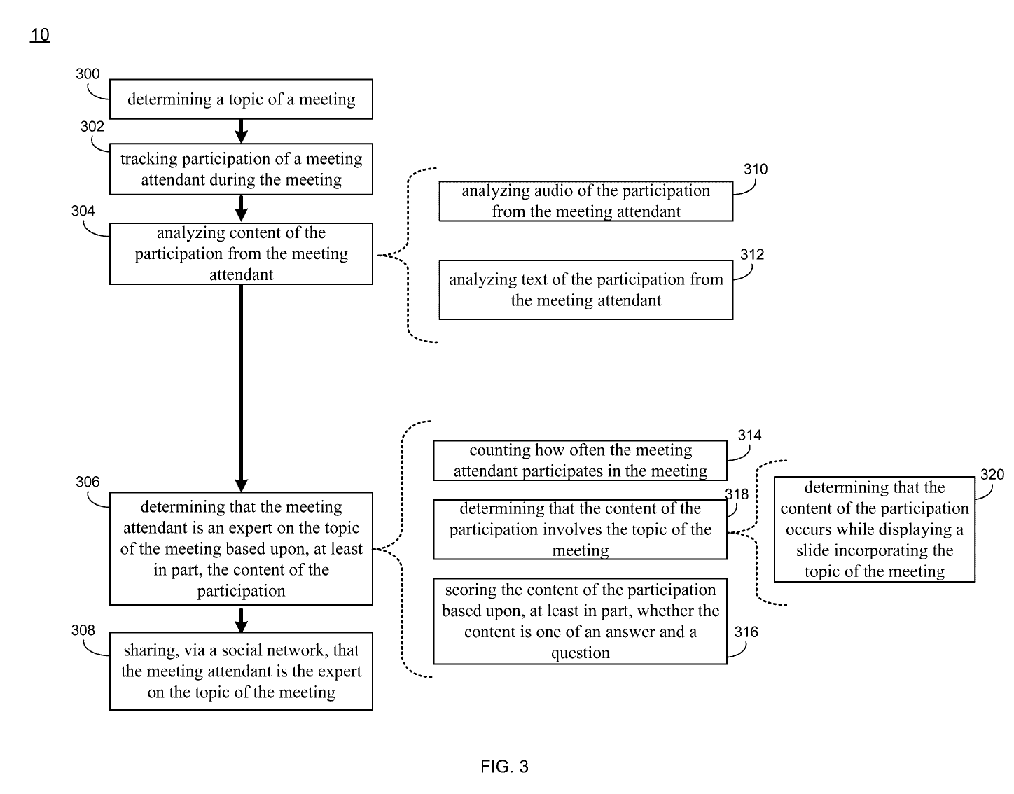

As discussed above and referring also at least to FIGS. 3-7, expert detection process 10 may determine 300 a topic of a meeting. Participation of a meeting attendant during the meeting may be tracked 302 by expert detection process 10. Content of the participation from the meeting attendant may be analyzed 304 by expert detection process 10. It may be determined 306 by expert detection process 10 that the meeting attendant is an expert on the topic of the meeting based upon, at least in part, the content of the participation. Expert detection process 10 may share 308, via a social network, that the meeting attendant is the expert on the topic of the meeting.

As will be discussed in greater detail below, expert detection process 10 may analyze someone's meeting participation, and using that analysis to provide weight for a social tag identifying the person's expertise. For instance, in meetings (e.g., online meetings), expert detection process 10 may track data about meeting attendees. For example, attendees may have the opportunity to participate in meeting room chats (e.g., IM) and to speak over the audio line for remote attendee interaction. In some implementations, the act of an attendant that attends a number of meetings on the same topic may flag that attendant as being interested in a particular topic. Information may be gleaned about the topic of the meeting based on, at least in part, keywords in the meeting title (e.g., identified via a calendar application associated with expert detection process 10), and keywords found in presented materials, chat, and audio. The same may apply to pure audio meetings, although they may not have an associated meeting room chat. Expert detection process 10 may track information about who is participating in a meeting, which may then be correlated by expert detection process 10 with the topics being discussed. As such, expert process 10 may glean information about topics about which a particular participant is knowledgeable. That information may be collected and then written back to social media environments by expert detection process 10, so that the information that a participant had expertise on that topic would not be limited to those attending the meeting.

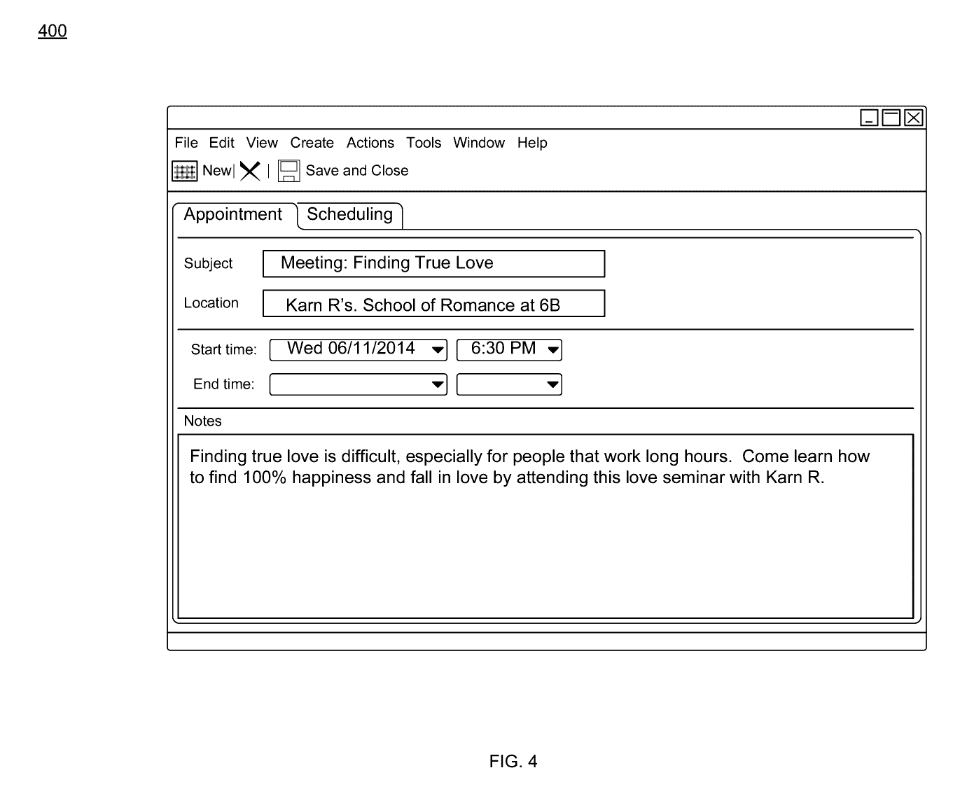

In some implementations, expert detection process 10 may determine 300 a topic of a meeting. For instance, and referring at least to FIG. 4, assume for example purposes only that a user (e.g., user 46) desires to attend a meeting. The details of the meeting (e.g., date, time, location, subject, etc.) may be stored in an application (e.g., a calendar/scheduling application) associated with expert detection process 10. In the example, expert detection process 10 may interact with the scheduling application to determine 300 the topic of the meeting. For instance, an example user interface 400 is shown in FIG. 4, where information about the meeting may be stored. In the example, the subject line reads, “Meeting: Finding True Love”, and a notes section reads, “Finding true love is difficult, especially for people that work long hours. Come learn how to find 100% happiness and fall in love by attending this love seminar with Karn R.”. In the example, expert detection process 10 may perform known keyword analysis on the scheduling application (e.g., the subject line and the notes section) to determine 300 that the topic of the meeting is “love”.

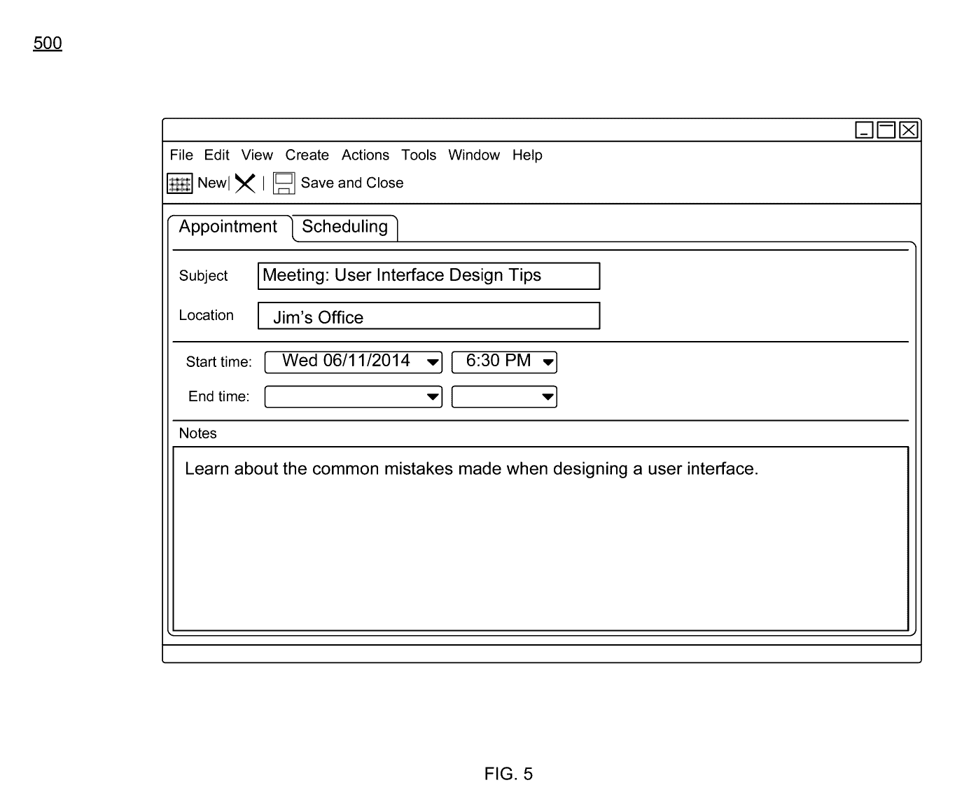

As another example, and referring at least to FIG. 5, an example user interface 500 is shown, where information about a different meeting may be stored. In the example, the subject line reads, “Meeting: User Interface Design Tips”, and a notes section reads, “Learn about the common mistakes made when designing a user interface”. In the example, expert detection process 10 may perform known keyword analysis on the scheduling application (e.g., the subject line and the notes section) to determine 300 that the topic of the meeting is “user interface” or “user interface design”.

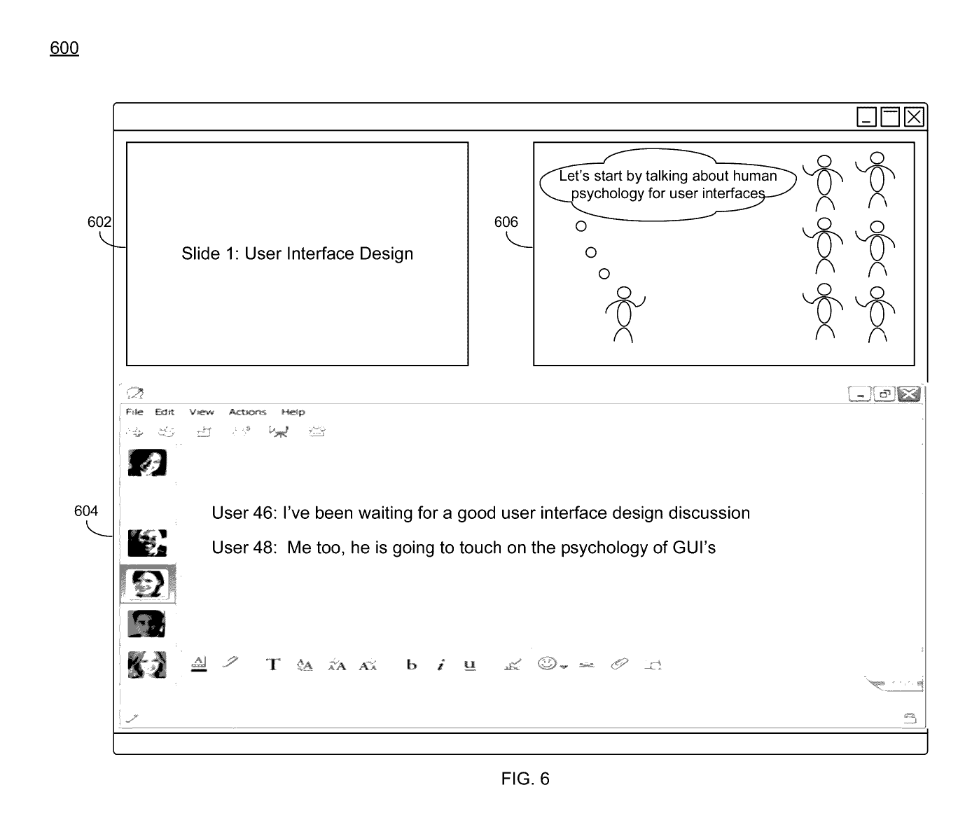

In some implementations, and referring at least to FIG. 6, expert detection process 10 may determine 300 the topic of a meeting by performing similar keyword analysis on meeting materials. For example, assume that the meeting is a virtual meeting. In the example, slides or other material (e.g., virtual handouts) may be presented for the meeting and displayed on display 212 at portion 602 of user interface 600, which may be analyzed by expert detection process 10 to determine the topic of the meeting. In the example, the slide reads, “Graphical User Interface Design”. In the example, expert detection process 10 may perform known keyword analysis on user interface 600 to determine 300 that the topic of the meeting is “user interface” or “user interface design”.

In some implementations, expert detection process 10 may determine 300 the topic of a meeting by performing similar keyword analysis on IM chats (e.g., conducted during the meeting). For example, and still referring at least to FIG. 6, assume that collaboration application 20 (e.g., via expert detection process 10) enables IMing during the meeting. In the example, the dialogue between attendants of the meeting may be presented and displayed on display 212 at portion 604 of user interface 600, which may be analyzed by expert detection process 10 to determine the topic of the meeting. In the example, user 46 (e.g., via expert detection process 10) may enter text via portion 604 that reads, “I've been waiting for a good user interface design discussion” and user 48 may enter text via portion 604 that reads, “Me too, he is going to touch on the psychology of GUI's”. In the example, expert detection process 10 may perform known keyword analysis on user interface 600 to determine 300 that the topic of the meeting is “user interface”, “user interface design”, or “GUI psychology”.

In some implementations, expert detection process 10 may determine 300 the topic of a meeting by performing similar keyword analysis on transcribed audio portions of the meeting. For example, and still referring at least to FIG. 6, assume that collaboration application 20 (e.g., via expert detection process 10) enables audio and/or video during the meeting. In the example, the (optional) video showing dialogue between attendants of the meeting that are speaking may be presented and displayed on display 212 at portion 606 of user interface 600. In the example, the dialogue may be transcribed by expert detection process 10 using known techniques, which may be analyzed by expert detection process 10 to determine 300 the topic of the meeting. In the example, audio from one of the presenters (e.g., via expert detection process 10) may be recorded with a recording device (e.g., microphone), which when analyzed (e.g., transcribed with subsequent keyword analysis) may read, “Let's start by talking about human psychology for user interfaces”. In the example, expert detection process 10 may perform known keyword analysis on the audio to determine 300 that the topic of the meeting is “user interface”, “user interface design”, or “psychology”.

It will be appreciated that any other techniques for determining 300 the topic of a meeting may be used without departing from the scope of the disclosure. As such, using the techniques described throughout should be taken as an example only and not to limit the scope of the disclosure.

In some implementations, participation of a meeting attendant during the meeting may be tracked 302 by expert detection process 10. For instance, assume for example purposes only that a meeting attendant (e.g., user 46) participates during the meeting. For example, user 46 may ask a question to the meeting presenter and expert process 10 may track 302 that fact. As another example, user 46 may answer a question posed by the meeting presenter or another meeting attendant and expert process 10 may track 302 that fact. As yet another example, user 46 may (via portion 604) IM someone during the meeting and expert process 10 may track 302 that fact. Expert detection process 10 may store the tracked information, which may identify who is speaking (e.g., via facial recognition at portion 606 or via a flag noting the user in portion 604), may identify whether it was a question or an answer (e.g., using the above-noted techniques), and may identify the type of participation (e.g., IM participation, oral participation, etc.)

In some implementations, content of the participation from the meeting attendant may be analyzed 304 by expert detection process 10. For instance, as noted above, expert detection process 10 may identify who is speaking, may identify whether it was a question or an answer, may identify the type of participation (e.g., IM participation, oral participation, etc.), and may further identify, track 302 and store the content of the participation. For example, in some implementations, analyzing 304 content of the participation from the meeting attendant may include analyzing 310 audio of the participation from the meeting attendant. In the example, the (optional) video showing dialogue between attendants of the meeting that are speaking may be presented and displayed on display 212 at portion 606 of user interface 600. In the example, the dialogue may be analyzed and transcribed by expert detection process 10 using known techniques, which may be analyzed 310 by expert detection process 10 to determine the content of the participation (e.g., what is being said). In the example, audio from one of the attendants (e.g., via expert detection process 10) may be recorded with a recording device (e.g., microphone), which when analyzed 310 (e.g., transcribed with subsequent keyword analysis) may identify who is speaking (e.g., via voice recognition), whether it was a question or an answer, and/or any other information pertaining to the content of what was said, such as the topic.

In some implementations, analyzing 304 content of the participation from the meeting attendant may include analyzing 312 text of the participation from the meeting attendant. For example, as noted above, the dialogue between attendants of the meeting may be presented and displayed on display 212 at portion 604 of user interface 600, which may be analyzed 312 by expert detection process 10 to determine the content of the participation. In the example, user 46 (e.g., via expert detection process 10) may enter text via portion 604 that reads, “I′ve been waiting for a good user interface design discussion” and user 48 may enter text via portion 604 that when analyzed 312 may identify who is speaking, whether it was a question or an answer, and/or any other information pertaining to the content of what was said, such as the topic.

In some implementations, expert detection process 10 may determine 306 that the meeting attendant is an expert on the topic of the meeting based upon, at least in part, the content of the participation. For example, in some implementations, determining 306 that the meeting attendant is the expert on the topic of the meeting may include counting 314 how often the meeting attendant participates in the meeting. For instance, expert detection process 10 may keep a “point” counter of each time a participant (e.g., user 46) spoke, and/or each time user 46 wrote to the meeting room chat via portion 604 of user interface 600. In the example, it may be assumed that someone who spoke more often than others may be tagged as an active participant in the topic of the meeting and may receive more points.

In some implementations, expert detection process 10 may provide a user interface that may enable a user (e.g., such as the presenter of the meeting) to view a list of attendants who were given tags for speaking, and may enable the presenter to remove people who may have spoken frequently but may have been off-topic, or disruptive.

In some implementations, determining 306 that the meeting attendant is the expert on the topic of the meeting may include scoring 316 the content of the participation based upon, at least in part, whether the content is one of an answer and a question. For example, as discussed above, audio and/or IM texts from one of the attendants (e.g., via expert detection process 10) may be analyzed 304 to determine whether the content of participation was in the form of a question or an answer. In the example, expert detection process 10 may score 316 more points for users with content that is an answer to a question than a question itself. Conversely, expert detection process 10 may score 316 less points for users with content that is an answer to a question than a question itself.

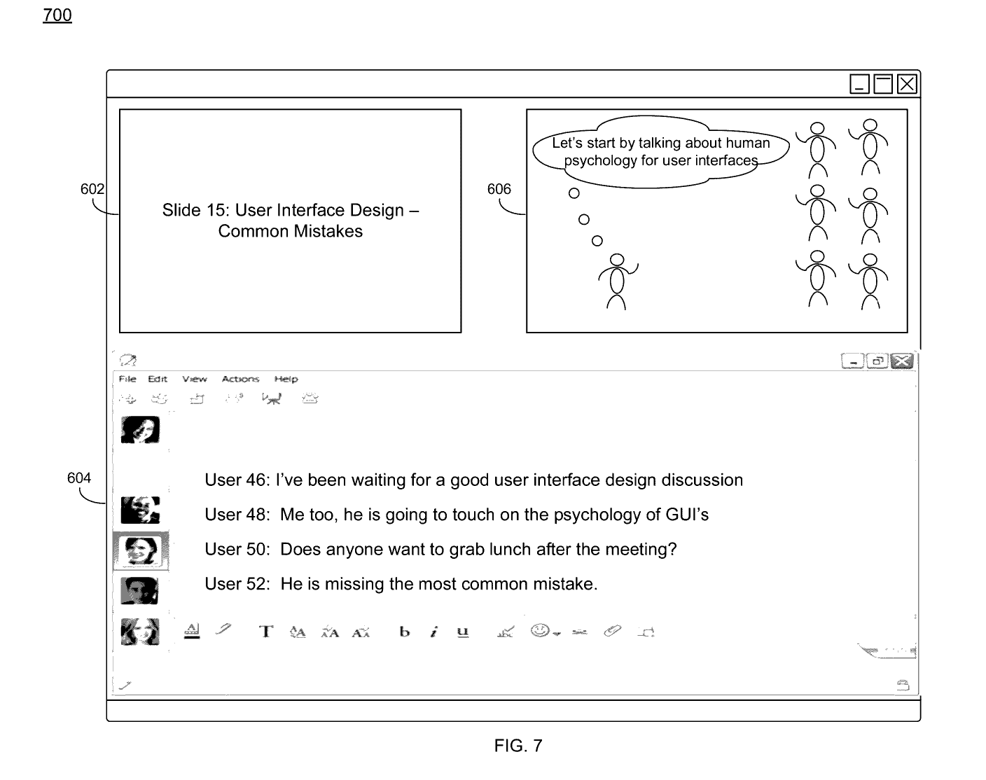

In some implementations, determining 306 that the meeting attendant is the expert on the topic of the meeting may include determining 318 that the content of the participation involves the topic of the meeting. For example, as noted above, audio and/or IM texts from one of the attendants (e.g., via expert detection process 10) may be analyzed 304 to determine the content of the participation matches the topic being discussed in the meeting. For instance, and referring at least to FIG. 7, the dialogue between attendants of the meeting may be presented and displayed on display 212 at portion 604 of user interface 700, which may be analyzed 312 by expert detection process 10 to determine 318 whether or not the content of the participation involves the topic of the meeting. In the example, user 46 (e.g., via expert detection process 10) may enter text via portion 604 that reads, “I′ve been waiting for a good user interface design discussion” and user 50 may enter text via portion 604 that reads, “Does anyone want to grab lunch after the meeting?” that when analyzed 312 may identify who is speaking, and that the content of the participation does not deal with the determined 300 topic of, e.g., user interface design.

In some implementations, determining 306 that the content of the participation involves the topic of the meeting may include determining 320 that the content of the participation occurs while displaying a slide incorporating the topic of the meeting. For instance, assume for example purposes only that the speaker is speaking to more granular information about what is being presented. For example, the speaker may cover multiple topics or even sub-topics. Using the above-analysis, expert detection process 10 may obtain more specific data on an attendant's expertise in the meeting that might cover one or more of those multiple topics or even sub-topics. The information gleaned from their participation, with this additional analysis, may provide a measure of quality to the person's contribution. For example, and referring still at least to FIG. 7, expert detection process 10 may, using similar analysis as discussed above, determine 306 that the content of the participation involves the topic of the meeting by determining 320 that the content of the participation occurs while displaying a slide incorporating the topic of the meeting. For example, assume that a particular slide (e.g., slide 15) or other material (e.g., virtual handouts) is currently being presented for the meeting and displayed on display 212 at portion 602 of user interface 700, which may be analyzed by expert detection process 10 to determine the current topic or sub-topic of the meeting. In the example, the slide reads, “Graphical User Interface Design—Common Mistakes”. In the example, expert detection process 10 may perform known keyword analysis on user interface 700 to determine 300 that the topic of the meeting at that moment in time is “user interface”, “user interface design”, and/or “common mistakes”. In the example, user 52 (e.g., via expert detection process 10) may enter text via portion 604 that reads, “He is missing the most common mistake” that when analyzed 312 may identify who is speaking, and that the content of the participation does deal with the determined 300 sub-topic of, e.g., common mistakes with user interface design. In the example, expert detection process 10 may score 316 more (or less) points for users with content participation that is determined 306 to involve the topic and/or sub-topic of the slide currently being displayed (and/or involves the topic and/or sub-topic of a slide not currently being displayed, but is within a predetermined number of slides from the currently displayed slide). For example, expert detection process 10 may score 316 more points for users with content participation that is determined 306 to involve the topic and/or sub-topic of the previous 3 slides. As another example, expert detection process 10 may score 316 more points for users with content participation that is determined 306 to involve the topic and/or sub-topic of the slide for a threshold amount of time (e.g., 30 seconds) after the slide has changed (and is no longer displayed).

In some implementation, expert detection process 10 may share 308, via a social network, that the meeting attendant is the expert on the topic of the meeting. For example, once it is determined 306 that the meeting attendant is an expert on the topic of the meeting (e.g., via a threshold number of points being awarded or other metric), expert detection process 10 may share 308, via a social network, that the meeting attendant is the expert on the particular topic of the meeting by, e.g., feeding positive participation back to social media engines to publicize the information, such as creating tags for participants or creating badges for them. Examples of social networks may include, e.g., Facebook, LinkedIn, and IBM Connections. The tags/badges may be located on a profile page of the attendant via the social network, and may be searchable. It will be appreciated that any technique of publicizing that an attendant is an expert in a topic may be used without departing from the scope of the disclosure. As such, the use of tags and badges should be taken as example only and not to limit the scope of the disclosure.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
determining, by a computing device, a topic of a meeting;
tracking participation of a meeting attendant during the meeting;
analyzing content of the participation from the meeting attendant;
determining that the meeting attendant is an expert on the topic of the meeting based upon, at least in part, the content of the participation; and
sharing, via a social network, that the meeting attendant is the expert on the topic of the meeting.

2. The computer-implemented method of claim 1 wherein determining that the meeting attendant is the expert on the topic of the meeting includes counting how often the meeting attendant participates in the meeting.

3. The computer-implemented method of claim 1 wherein determining that the meeting attendant is the expert on the topic of the meeting includes determining that the content of the participation involves the topic of the meeting.

4. The computer-implemented method of claim 3 wherein determining that the content of the participation involves the topic of the meeting includes determining that the content of the participation occurs while displaying a slide incorporating the topic of the meeting.

5. The computer-implemented method of claim 1 wherein analyzing content of the participation from the meeting attendant includes analyzing audio of the participation from the meeting attendant.

6. The computer-implemented method of claim 1 wherein analyzing content of the participation from the meeting attendant includes analyzing text of the participation from the meeting attendant.

7. The computer-implemented method of claim 1 wherein determining that the meeting attendant is the expert on the topic of the meeting includes scoring the content of the participation based upon, at least in part, whether the content is one of an answer and a question.

8. A computer program product residing on a computer readable storage medium having a plurality of instructions stored thereon which, when executed by a processor, cause the processor to perform operations comprising:
determining a topic of a meeting;
tracking participation of a meeting attendant during the meeting;
analyzing content of the participation from the meeting attendant;
determining that the meeting attendant is an expert on the topic of the meeting based upon, at least in part, the content of the participation; and
sharing, via a social network, that the meeting attendant is the expert on the topic of the meeting.

9. The computer program product of claim 8 wherein determining that the meeting attendant is the expert on the topic of the meeting includes counting how often the meeting attendant participates in the meeting.

10. The computer program product of claim 8 wherein determining that the meeting attendant is the expert on the topic of the meeting includes determining that the content of the participation involves the topic of the meeting.

11. The computer program product of claim 10 wherein determining that the content of the participation involves the topic of the meeting includes determining that the content of the participation occurs while displaying a slide incorporating the topic of the meeting.

12. The computer program product of claim 8 wherein analyzing content of the participation from the meeting attendant includes analyzing audio of the participation from the meeting attendant.

13. The computer program product of claim 8 wherein analyzing content of the participation from the meeting attendant includes analyzing text of the participation from the meeting attendant.

14. The computer program product of claim 8 wherein determining that the meeting attendant is the expert on the topic of the meeting includes scoring the content of the participation based upon, at least in part, whether the content is one of an answer and a question.

15. A computing system including a processor and a memory configured to perform operations comprising:
determining a topic of a meeting;
tracking participation of a meeting attendant during the meeting;
analyzing content of the participation from the meeting attendant;
determining that the meeting attendant is an expert on the topic of the meeting based upon, at least in part, the content of the participation; and
sharing, via a social network, that the meeting attendant is the expert on the topic of the meeting.

16. The computing system of claim 15 wherein determining that the meeting attendant is the expert on the topic of the meeting includes counting how often the meeting attendant participates in the meeting.

17. The computing system of claim 15 wherein determining that the meeting attendant is the expert on the topic of the meeting includes determining that the content of the participation involves the topic of the meeting.

18. The computing system of claim 17 wherein determining that the content of the participation involves the topic of the meeting includes determining that the content of the participation occurs while displaying a slide incorporating the topic of the meeting.

19. The computing system of claim 15 wherein analyzing content of the participation from the meeting attendant includes analyzing audio of the participation from the meeting attendant.

20. The computing system of claim 15 wherein analyzing content of the participation from the meeting attendant includes analyzing text of the participation from the meeting attendant.
